(19) United States
(12) Patent Application Publication
(10) Pub. No.: US 2008/0209341 A1
(43) Pub. Date: Aug. 28, 2008

(54) INFORMATION PROCESSING DEVICE, COMPUTER READABLE MEDIUM, AND COMPUTER DATA SIGNAL

(75) Inventor: Takaaki KASHIWAGI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/858,552

(22) Filed: Sep. 20, 2007

(30) Foreign Application Priority Data
Feb. 28, 2007 (JP) 2007-048435

(51) Int. Cl. G06F 3/00

(52) U.S. Cl. 715/747

(57) ABSTRACT

There is provided an information processing device, which: causes a holding unit to hold a holding unit that holds selection elements to be displayed and to be targets for selection by a user on a screen and setting information for each of the selection elements about whether to display or not on the screen; a change unit that changes the setting information for each of the selection elements according to time; and a display control unit that displays the selection elements on the screen based on the setting information.

### CROSS-REFERENCE TO RELATED APPLICATIONS

This application is based on and claims priority under 35 USC 119 from Japanese Patent Application No. 2007-048435 filed Feb. 28, 2007.

### BACKGROUND

1. Technical Field

The present invention relates to an information processing device, a computer readable medium, and a computer data signal.

2. Related Art

In recent years, information processing devices equipped with a graphical user interface (GUI) function have become widespread. In such information processing devices, selection elements to be targets for selection by a user, etc., are displayed on a screen. In addition, kinds, arrangements, and the like of the selection elements displayed on the screen may be changed into desired states according to the user's wishes.

### SUMMARY

According to an aspect of the present invention, there is provided an information processing device including:

a holding unit that holds selection elements to be displayed and to be targets for selection by a user on a screen and setting information for each of the selection elements about whether to display or not on the screen; a change unit that changes the setting information for each of the selection elements according to time; and a display control unit that displays the selection elements on the screen based on the setting information.

### BRIEF DESCRIPTION OF THE DRAWINGS

An exemplary embodiment of the present invention will be described in detail based on the following figures, wherein:

FIG. 1 is a block diagram showing an example of a construction of an information processing device according to an exemplary embodiment of the present invention;

FIG. 2 is a diagram showing an example of display by the information processing device;

FIG. 3 is a diagram showing an example of contents of an object data list;

FIG. 4 is a diagram showing an example of contents of a user interface data list;

FIG. 5 is a diagram showing an example of contents of a task data list;

FIG. 6 is a flowchart showing an example of an operation of the information processing device;

FIG. 7 is a diagram showing an example of display by the information processing device;

FIG. 8 is a diagram showing an example of display of a task creation tool;

FIG. 9 is a block diagram showing a modification of the information processing device;

FIG. 10 is a diagram showing a modification of the contents of the task data list;

FIG. 11 is a flowchart showing a modification of the operation of the information processing device; and

FIG. 12 shows a modification of the displaying of the task creation tool.

### DETAILED DESCRIPTION

An exemplary embodiment of the present invention will now be described with reference to the accompanying drawings.

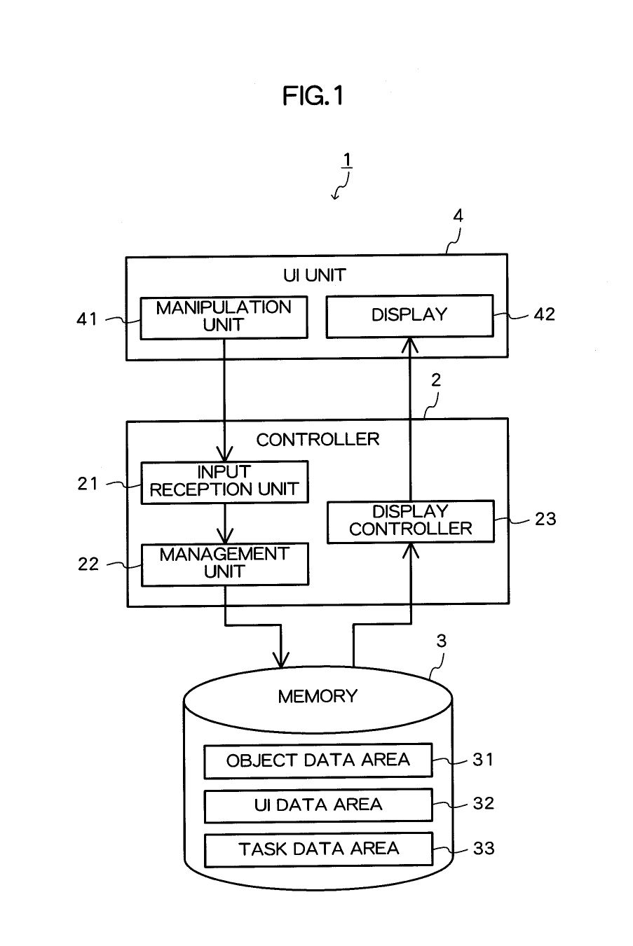

FIG. 1 is a block diagram showing an example of a construction of a personal computer (PC) 1 that is an exemplary embodiment of the information processing device according to the present invention. The PC 1 includes a controller 2 that takes overall control of the apparatus, a memory 3 constructed from a hard disk or the like, and a user interface unit (UI unit) 4 that realizes a graphical user interface (GUI) function.

The controller 2 is constructed from a CPU (central processing unit such as a microprocessor), a random access memory (RAM) that provides a work area used by the CPU, and the like. The controller 2 functionally includes an input reception unit 21, a management unit 22, and a display controller 23. These structural elements are realized by an operation based on software of the CPU included in the controller 2.

The memory 3 stores a program and data that are necessary for the operation of the CPU of the controller 2. These program and data may be distributed after being recorded on a medium, such as a CD-ROM, or may be distributed through a communication channel such as the Internet.

In the memory 3, there are provided an object data area 31 in which object data is stored, a user interface data area (UI data area) 32 in which user interface data (UI data) is stored, and a task data area 33 in which task data is stored.

The UI unit 4 is constructed from a manipulation unit 41 constructed from a combination of a keyboard and a mouse or the like and a display 42 constructed from a display apparatus or the like.

The input reception unit 21 of the controller 2 receives input of manipulation from the manipulation unit 41 manipulated by a user and outputs the received manipulation input to the management unit 22. Examples of this manipulation input include manipulation input for selection of a selection element displayed on the display 42, and the like. In addition, manipulation input for generating task data to be stored in the task data area 33 of the memory 3, and the like, are also included.

When the selection element displayed on the display 42 has been selected, the management unit 22 of the controller 2 carries out a predetermined operation corresponding to this selection element.

Also, the management unit 22 monitors the current time and changes the contents of a list of the object data stored in the object data area 31 of the memory 3 and a list of the UI data stored in the UI data area 32 based on the task data stored in the task data area 33 of the memory 3 according to the current time. The management unit 22 in this case corresponds to a change unit according to the present invention. Note that it is possible to perform the monitoring of the current time by referring to an internal clock of the computer, for instance. Alternatively, the current time may be obtained from an external server.

Further, when new task data has been inputted, the management unit 22 stores the task data in the task data area 33 of the memory 3.

The display controller 23 of the controller 2 displays a user interface screen (UI screen) on the display 42 based on the object data stored in the object data area 31 of the memory 3 and the UI data stored in the UI data area 32.

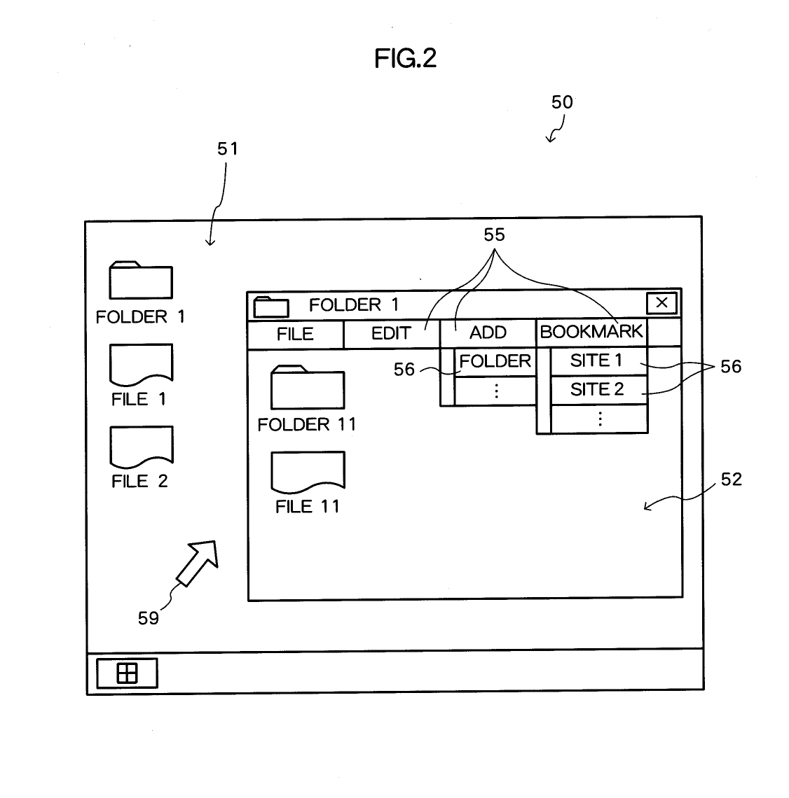

An example of the displaying of the UI screen is shown in FIG. 2. A UI screen 50 is a screen, in which a state of a virtual space where objects expressing files, folders, and the like are arranged is displayed, and includes a desktop screen (basic screen) 51, an in-folder display tool screen 52 in which the contents of the folders are displayed, and the like. Here, the desktop and the folders express predetermined hierarchies included in a file system.

The objects arranged in the UI screen 50 are generated based on the object data stored in the object data area 31 of the memory 3. As for the objects, there are various kinds such as file objects expressing files like document files and folder objects expressing folders (also referred to as directories). In addition, there are also shortcut objects, which refer to files or the like, and the like.

Such objects are targets for selection with a pointer 59 or the like that moves in the UI screen 50 by following manipulation inputted to the manipulation unit 41. In other words, the objects arranged in the UI screen 50 functions as selection elements.

When a file object has been selected, a file corresponding to the file object is opened and a screen showing the contents of the file is displayed, for instance. Also, when a folder object has been selected, the in-folder display tool screen 52 showing the contents of the folder is displayed, for instance. Further, when a shortcut object has been selected, a file that is a reference destination is opened and a screen showing the contents of the file is displayed, for instance.

On the other hand, the desktop screen 51, the in-folder display tool screen 52, and the like constituting the UI screen 50 are generated based on the UI data stored in the UI data area 32 of the memory 3.

Among these, in the in-folder display tool screen 52, menus 55, items 56, and the like are embedded. These are targets for selection with the pointer 59 or the like. In other words, the menus 55, the items 56, and the like included in the UI screen 50 functions as selection elements.

When a menu 55 has been selected, a list of items 56 belonging to the menu 55 is pulled down and displayed, for instance. Also, when an item 56 has been selected, a predetermined instruction corresponding to the item 56 is executed, for instance. Examples of the predetermined instruction include an instruction to save a file, an instruction to copy a file, an instruction to add a new folder, an instruction to access a site, and the like.

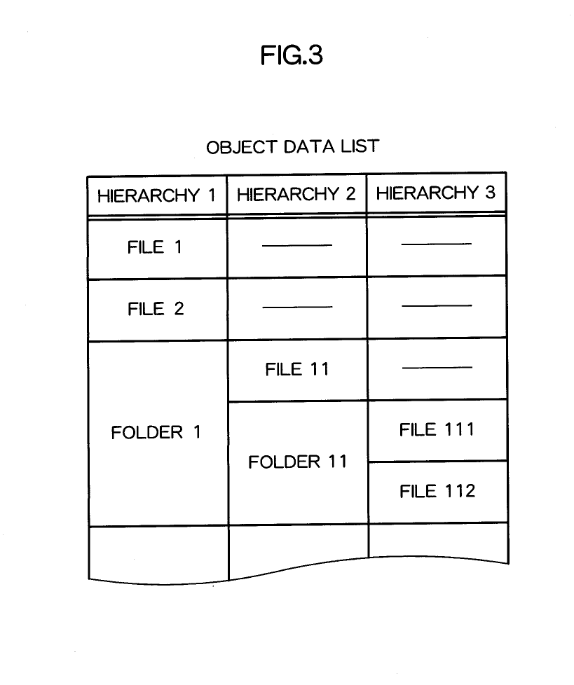

The object data stored in the object data area 31 of the memory 3 is managed by an object data list shown in FIG. 3, for instance. On the object data list, information showing which object should be arranged in which hierarchy is described. The display controller 23 of the controller 2 arranges the objects expressing the files, the folders, and the like in respective hierarchies such as the desktop and the folders, based on the object data list. The object data list is stored in the object data area 31 of the memory 3 together with the object data. The memory 3 in this case corresponds to a holding unit according to the present invention.

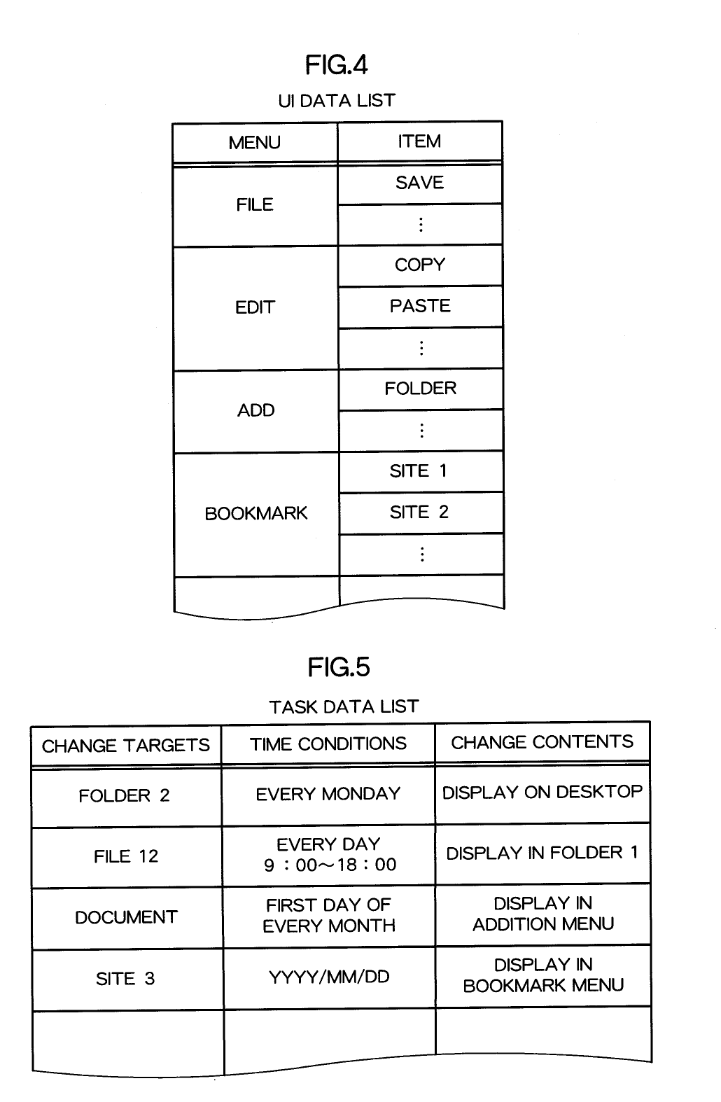

On the other hand, the UI data stored in the UI data area 32 of the memory 3 is managed by a user interface data list (UI data list) shown in FIG. 4, for instance. On the UI data list, information showing a manner in which the UI screen 50 should be configured is described, and in particular information showing the kinds of the menus 55 embedded in the in-folder display tool screen 52, the kinds of the items 56 belonging to respective menus 55, and the like is described. The display controller 23 of the controller 2 configures the UI screen 50, in other words, the desktop screen 51, the in-folder display tool screen 52, and the like based on the UI data list. The UI data list is stored in the UI data area 32 of the memory 3 together with the UI data. The memory 3 in this case also corresponds to the holding unit according to the present invention.

In FIG. 5, an example of the contents of the task data stored in the task data area 33 of the memory 3 is shown. The task data is used in a change of the contents of the object data list and the UI data list. In this task data, change targets, time conditions, and change contents are described. The change targets identify selection elements that are targets of changes. The time conditions identify time when the changes should be valid.

When a target of a change is an object that should be arranged in the UI screen 50, for instance, the task data identifies the object that is the target of the change, identifies a hierarchy in which the object should be arranged, and identifies a time when the object should be arranged.

Also, when the target of the change is an item 56 that should constitute the UI screen 50, for instance, the task data identifies the item that is the target of the change, identifies a menu in which the item should be included, and identifies a time when the item should be included.

It should be noted here that in these examples, a case of a change, in which a specific selection element is displayed at a predetermined time, has been described, but the present invention is not limited to this and a change in which displaying of a specific selection element is stopped at a predetermined time may be made instead.

It is possible to identify the time, when the change should be valid, with a start time and an end time, for instance. Alternatively, the time may be set to all day long (in other words, a start of a day is set as the start time and an end of the day is set as the end time). As a further alternative, the time identified in this manner may be set to a regular time such as every day, a predetermined day of every week, or a predetermined day of every month. Alternatively, a case where the time is indirectly identified, such as a case where another selection element that is a change target is displayed (or is not displayed), is also possible.

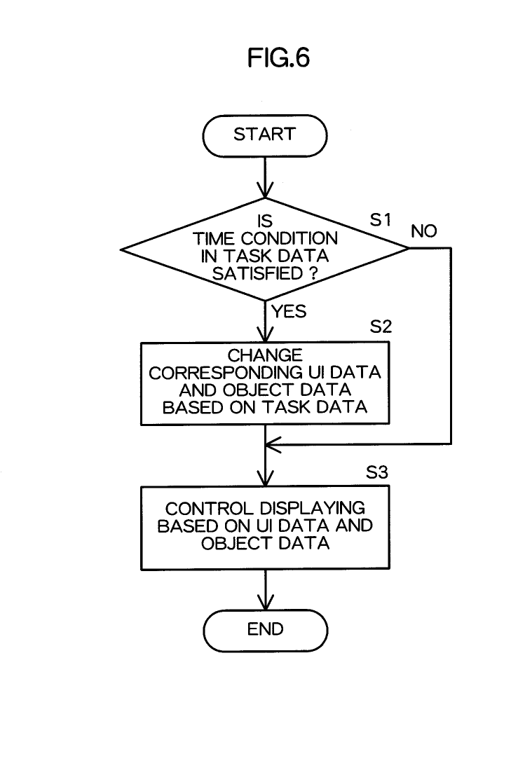

Hereinafter, an example of an operation of the controller 2 in the case where the selection element displayed on the display 42 is changed by using the task data will be described. FIG. 6 is a flowchart showing this operation example.

The management unit 22 of the controller 2 monitors the current time and judges whether the current time satisfies a time condition described in the task data stored in the task data area 33 of the memory 3 (S1).

When the current time satisfies the time condition in the task data (S1: YES), the management unit 22 changes the contents of the object data list stored in the object data area 31 of the memory 3 and the UI data list stored in the UI data area 32 based on the task data (S2).

When a target of a change is an object that should be arranged in the UI screen 50, for instance, the management unit 22 rewrites the object data list so that the object that is the change target is to be arranged in a hierarchy identified by the change contents.

Also, when the target of the change is an item 56 that should constitute the UI screen 50, for instance, the management unit 22 rewrites the UI data list so that the item that is the change target is to be included in a menu identified by the change contents.

The display controller 23 of the controller 2 displays the UI screen 50 on the display 42 using the object data and the UI data based on the object data list and the UI data list (S3).

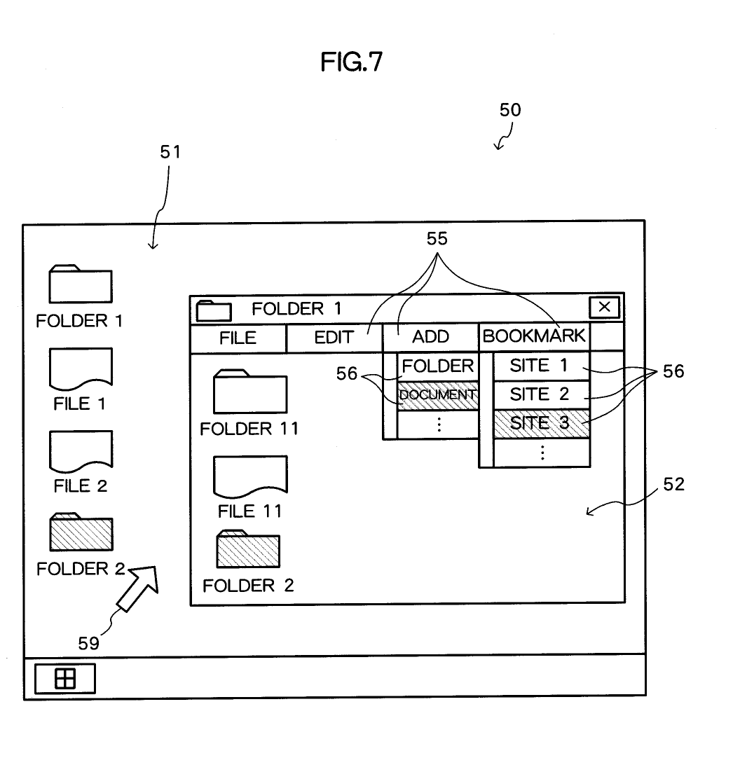

In FIG. 7, an example of the displaying of the UI screen in the case where the contents of the object data list and the UI data list have been changed is shown. In the drawing, an example is shown of the displaying in the case where every time condition in the task data shown in FIG. 5 described above is satisfied. As shown in the drawing, in the UI screen 50, selection elements that are change targets are displayed. In other words, in the desktop screen 51 and the in-folder display tool screen 52 included in the UI screen 50, objects that are change targets are arranged. Also, in menus 55 embedded in the in-folder display tool, items 56 that are change targets are included.

Here, it is possible to display the selection elements that are the change targets so as to be distinguishable from selection elements that are not the change targets. For instance, a method is usable with which displaying is performed by making a display form, such as a shape, a pattern, or a color, of the selection elements that are the change targets, and those of the selection elements that are not the change targets, different from each other. In addition, for instance, a method is also usable with which display positions of the selection elements that are not the change targets are not changed, and the selection elements that are the change targets are displayed at positions not overlapping the display positions. Still further, a method is also usable with which an area, in which the selection elements that are the change targets are arranged, and an area, in which the selection elements that are not the change targets are arranged, are separated from each other, thereby preventing mixing between the selection elements that are the change targets and the selection elements that are not the change targets.

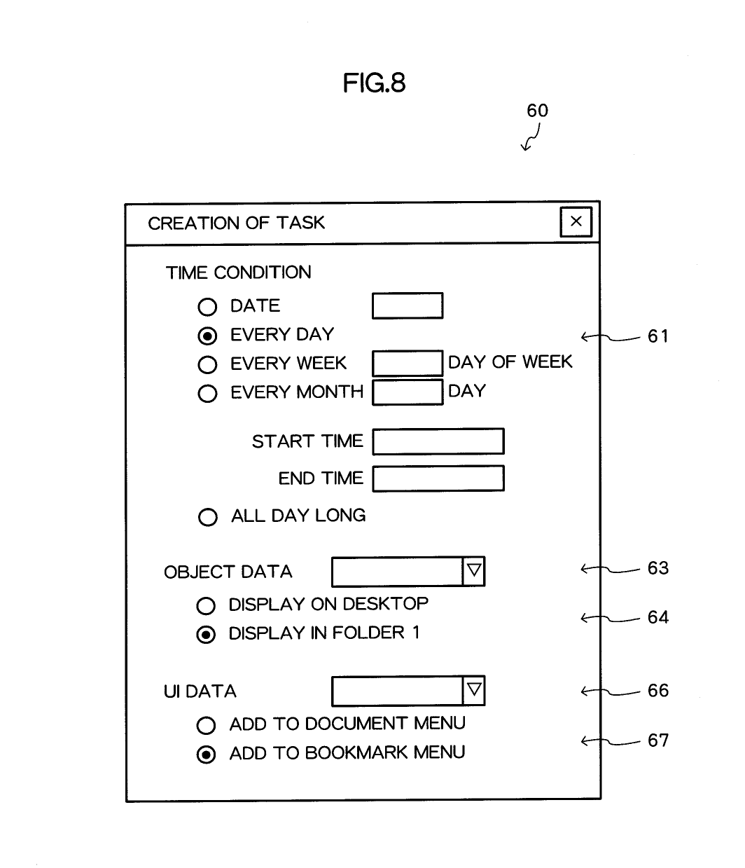

Next, processing in the case where the task data is registered in the task data area 33 of the memory 3 by the management unit 22 will be described. The management unit 22 displays a task creation tool 60 shown in FIG. 8 or the like on the display 42 and receives input of the task data. The task creation tool 60 includes a time condition input area 61 for receiving input of a time condition such as a time in which a change should be valid, change target input areas 63 and 66 for receiving input of a selection element that is a change target, and change contents input areas 64 and 67 for receiving input of change contents. When a target of a change is an object that should be arranged in the UI screen 50, the change target input area 63 and the change contents input area 64 are used. Also, when the target of the change is an item 56 that should constitute the UI screen 50, the change target input area 66 and the change contents input area 67 are used.

The management unit 22 generates the task data from contents inputted into such input areas and registers the generated task data by storing the data in the task data area 33 of the memory 3.

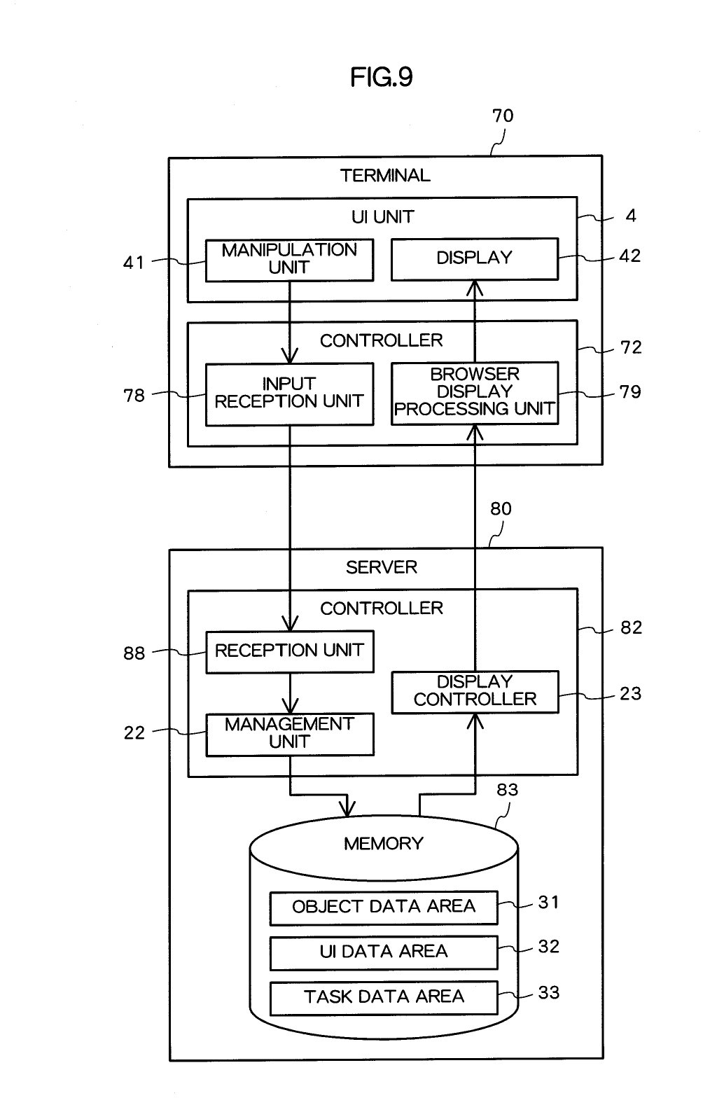

Hereinafter, a modification of the present invention will be described. FIG. 9 is a block diagram showing an example of a construction of a server apparatus 80 that is a modification of the information processing device according to the present invention and an example of a construction of a terminal 70 connected to the server apparatus 80. Note that each structural component that is the same as in the exemplary embodiment described above is given the same reference numeral, and the detailed description thereof will be omitted.

The server apparatus 80 and the terminal 70 are set communicable with each other through a communication channel such as a network. It is possible to construct the server apparatus 80 as an application server that provides a function of an application to the terminal 70, for instance.

The terminal 70 includes a controller 72 that takes overall control of the apparatus and an UI unit 4 constructed from a manipulation unit 41 and a display 42. The controller 72 is constructed from a CPU, a RAM, and the like and functionally includes an input reception unit 78 and a browser display processing unit 79 through an operation based on software of the CPU.

The browser display processing unit 79 of the terminal 70 displays a browser screen (browsing screen) on the display 42 and displays a screen based on the function of the application provided from the server apparatus 80 in the browser screen.

The input reception unit 78 of the terminal 70 receives manipulation input from the manipulation unit 41 manipulated by a user and outputs information concerning the received input to the server apparatus 80. Examples of the manipulation input include a manipulation input for selection of selection elements included in the browser screen displayed on the display 42, and the like.

The server apparatus 80 includes a controller 82 that takes overall control of the apparatus, and a memory 83 constructed from a hard disk or the like. The controller 82 is constructed from a CPU, a RAM, and the like and functionally includes a reception unit 88, a management unit 22, and a display controller 23 through an operation based on software of the CPU. Also, an object data area 31, a UI data area 32, and a task data area 33 are provided in the memory 83.

The reception unit 88 of the server apparatus 80 receives the information concerning the manipulation input from the terminal 70 and outputs this received information to the management unit 22.

When a selection element included in the browser screen displayed on the display 42 has been selected, the management unit 22 of the server apparatus 80 carries out a predetermined operation corresponding to the selection element.

The display controller 23 of the server apparatus 80 generates data for displaying the screen based on the function of the application in the browser screen of the terminal 70, based on object data stored in the object data area 31 of the memory 3 and UI data stored in the UI data area 32, and transmits the generated data to the terminal 70.

As a result, in the screen based on the function of the application displayed in the browser screen of the terminal 70, objects generated based on the object data stored in the object data area 31 of the memory 3 are arranged. The objects arranged in this manner function as selection elements.

Also, the screen based on the function of the application displayed in the browser screen of the terminal 70 is generated based on the UI data stored in the UI data area 32 of the memory 3. Menus, items, and the like are included in the screen, with these functioning as selection elements.

A concrete operation of the controller 82 of the server apparatus 80 will be described. First, as in the case of the exemplary embodiment described above, the management unit 22 monitors the current time and judges whether the current time satisfies a time condition in task data stored in the task data area 33 of the memory 3.

When the current time satisfies the time condition in the task data, the management unit 22 changes the contents of an object data list stored in the object data area 31 of the memory 3 and a UI data list stored in the UI data area 32 based on the task data.

Following this, the display controller 23 generates data for displaying the screen based on the function of the application in the browser screen of the terminal 70 using the object data and the UI data based on the object data list and the UI data list, and transmits the generated data to the terminal 70.

Next, an operation of the server apparatus 80 that is a modification of the operation in the exemplary embodiment described above will be explained.

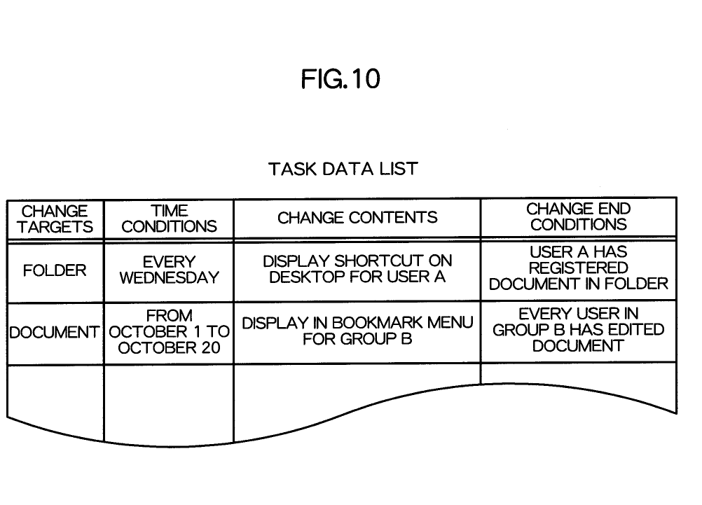

In FIG. 10, a modification of the contents of the task data is shown. In the task data, in addition to change targets, time conditions, and change contents, change end conditions are described.

Each change end condition identifies a condition for ending a change of the contents of the object data list and the UI data list. In other words, the change end condition identifies a condition for ending (invalidating) the change that is valid in a time identified by a time condition. Note that the change end condition identifies a condition other than such a condition where the current time satisfies the time condition has ended. Note that it is suitable for the change end condition to identify a condition other than a time-related condition.

More specifically, it is possible to set a situation, in which predetermined processing has been carried out with respect to an object or the like that is a change target, or the like, as the change end condition. For instance, it is possible to set a situation where a document file has been registered in a folder that is a change target, a situation where a document file that is a change target has been edited, or the like, as the change end condition. Here, the change end condition may also relate to which user carried out this processing, or to which group a user who carried out the processing belongs.

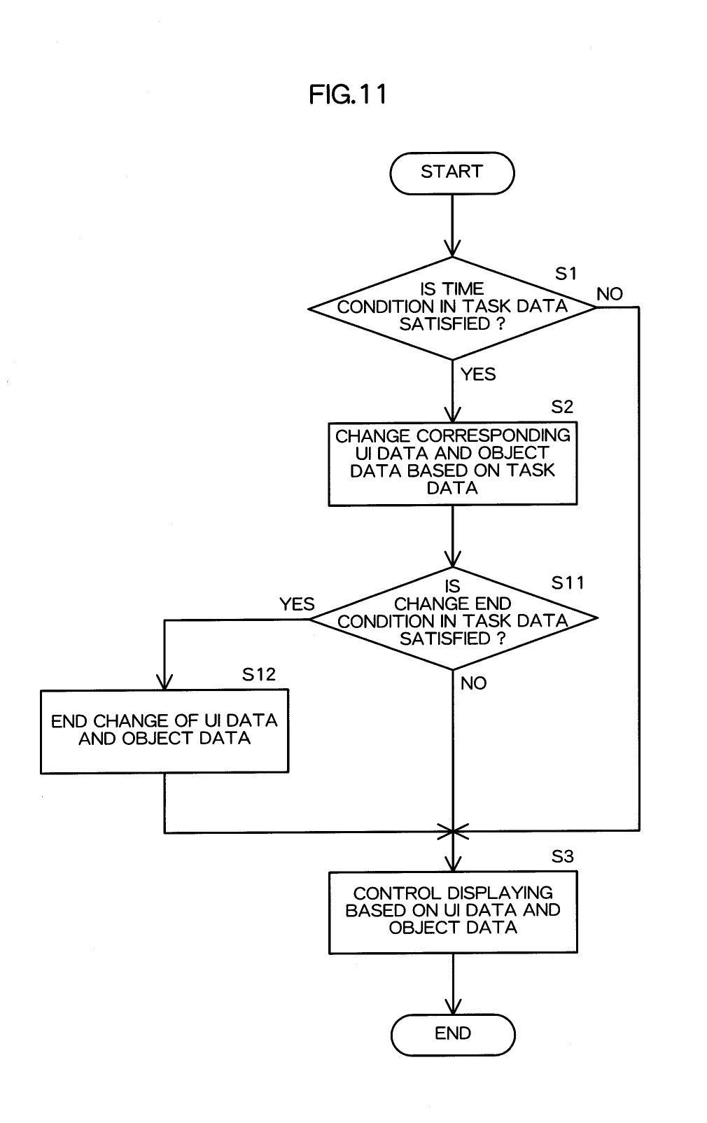

FIG. 11 is a flowchart showing an example of the operation of the server apparatus 80 in the case where the task data including the change end condition shown in FIG. 10 described above is used. Note that each step that is the same as in the flowchart shown in FIG. 6 described above is given the same step number, and the detailed description thereof will be omitted.

Here, it is possible to construct the server apparatus 80 to have a function of transmitting the data for displaying the screen based on the function of the application in the browser screen to plural terminals 70. In addition, it is possible to construct the server apparatus 80 to have a function of identifying the terminals 70 or identifying users authenticated by the terminals 70.

The management unit 22 of the server apparatus 80 judges whether the change end condition included in the task data is satisfied (S11) under a situation where the contents of the object data list or the UI data list have been changed based on the task data (S2).

When the change end condition included in the task data is satisfied (S11: YES), the management unit 22 of the server apparatus 80 ends the change of the contents of the object data list or the UI data list (S12).

When a situation where a document file has been registered in a folder that is a change target by a specific user is set as the change end condition, for instance, on detecting the situation where the document file has been registered in the folder that is the change target through manipulation input received from a terminal 70 that the specific user uses, the management unit 22 of the server apparatus 80 removes the folder that is the change target from the object data list. As a result, displaying of the folder that is the change target in the browser screen of the terminal 70 is ended.

Also, when a situation where a document file that is a change target has been edited by every user belonging to a specific group is set as the change end condition, for instance, when the document file that is the change target has been edited through manipulation input received from a terminal 70 that a user belonging to the specific group uses, the management unit 22 of the server apparatus 80 holds information showing this situation. Then, on detecting a situation where the information has been obtained for every user, the management unit 22 removes the document file that is the change target from the object data list. As a result, displaying of the document file that is the change target in the browser screen of the terminal 70 is ended.

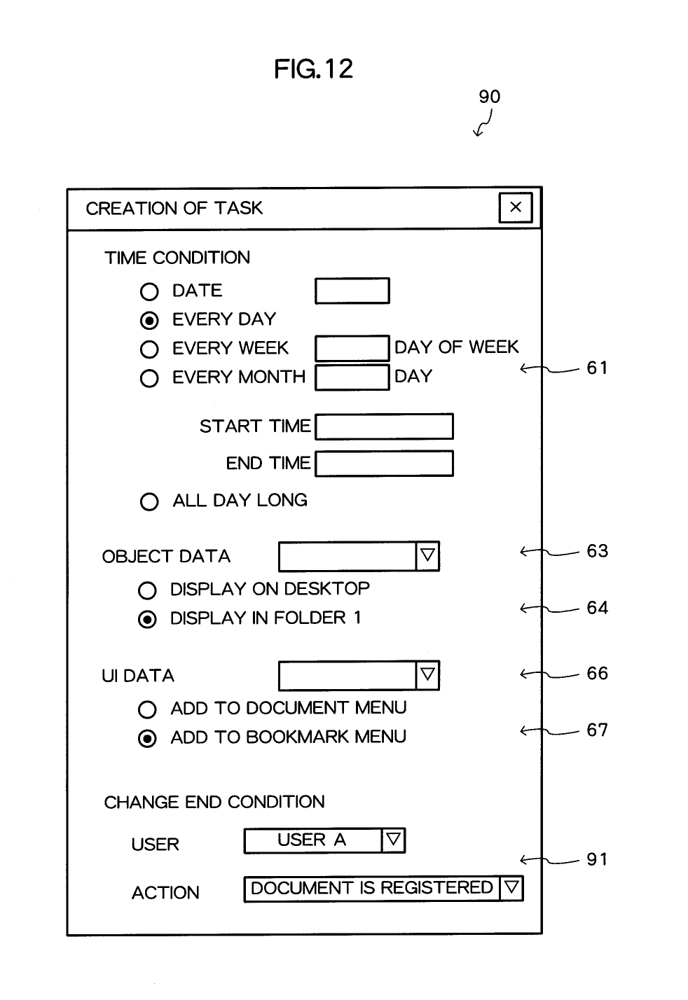

FIG. 12 shows an example of displaying of the task creation tool modified for the task data including the change end condition shown in FIG. 10 described above. Note that each structural element that is the same as a construction of the task creation tool shown in FIG. 8 described above is given the same reference numeral, and the detailed description thereof will be omitted. In addition to the time condition input area 61, the change target input areas 63 and 66, and the change contents input areas 64 and 67, a task creation tool 90 includes a change end condition input area 91 for receiving input of the change end condition. In the change end condition input area 91, information concerning a user and information concerning processing carried out are inputted as the change end condition.

What is claimed is:

1. An information processing device, comprising:
a holding unit that holds selection elements to be displayed and to be targets for selection by a user on a screen and setting information for each of the selection elements about whether to display or not on the screen;
a change unit that changes the setting information for each of the selection elements according to time; and
a display control unit that displays the selection elements on the screen based on the setting information.

2. The information processing device according to claim 1, wherein each of the selection elements comprises at least one of a file object, a folder object, and a shortcut object.

3. The information processing device according to claim 1, wherein each of the selection elements comprises at least one of a menu and an item for instructing manipulation with respect to an object displayed on the screen.

4. The information processing device according to claim 1, further comprising a storage unit that stores setting change valid time information, which indicates a time at which the change of the setting information for each of the selection elements becomes valid, in a memory,
wherein the change unit changes the setting information for each of the selection elements based on the setting change valid time information.

5. The information processing device according to claim 1, wherein the change unit carries out the change of the setting information for each of the selection elements when a predetermined condition concerning the selection elements is satisfied.

6. A computer readable medium recording therein a program that causes a computer to execute a process comprising:
holding, by a holding unit, selection elements to be displayed and to be targets for selection by a user on a screen and setting information for each of the selection elements about whether to display or not on the screen;
changing the setting information for each of the selection elements according to time; and
displaying the selection elements on the screen based on the setting information.

7. The computer readable medium according to claim 6 wherein each of the selection elements comprises at least one of a file object, a folder object, and a shortcut object.

8. The computer readable medium according to claim 1, wherein each of the selection elements comprises at least one of a menu and an item for instructing manipulation with respect to an object displayed on the screen.

9. The computer readable medium according to claim 6, wherein:
the program further causes the computer to execute storing setting change valid time information, which indicates a time at which the change of the setting information for each of the selection elements becomes valid, in a memory; and
the changing includes changing the setting information for each of the selection elements based on the setting change valid time information.

10. The computer readable medium according to claim 6, wherein the changing of the setting information for each of the selection elements is carried out when a predetermined condition concerning the selection elements is satisfied.

11. A computer data signal embodied in a carrier wave for enabling a computer to perform a process comprising:
holding, by a holding unit, selection elements to be displayed and to be targets for selection by a user on a screen and setting information for each of the selection elements about whether to display or not on the screen;
changing the setting information for each of the selection elements according to time; and
displaying the selection elements on the screen based on the setting information.

12. The computer data signal according to claim 11, wherein each of the selection elements comprises at least one of a file object, a folder object, and a shortcut object.

13. The computer data signal according to claim 11, wherein each of the selection elements comprises at least one of a menu and an item for instructing manipulation with respect to an object displayed on the screen.

14. The computer data signal according to claim 11, which further enables the computer to perform
storing setting change valid time information, which indicates a time at which the change of the setting information for each of the selection elements becomes valid, in a memory,
wherein the changing includes changing the setting information for each of the selection elements based on the setting change valid time information.

15. The computer data signal according to claim 11, wherein the changing of the setting information for each of the selection elements is carried out when a predetermined condition concerning the selection elements is satisfied.
